(19) United States
(12) Patent Application Publication
(10) Pub. No.: US 2023/0329469 A1
(43) Pub. Date: Oct. 19, 2023

(54) Package Security Assembly

(71) Applicant: Samuel Alvarez Garcia, Glen Cove, NY (US)

(72) Inventor: Samuel Alvarez Garcia, Glen Cove, NY (US)

(21) Appl. No.: 17/720,820

(22) Filed: Apr. 14, 2022

(51) Int. Cl. A47G 29/22; E05B 73/00

(52) U.S. Cl. CPC A47G 29/22; E05B 73/0011

(57) ABSTRACT

A package security assembly includes a mount housing that is mountable to a vertical support surface is located at a pre-determined location for a package delivery. A plurality of cables is each retractably integrated into the mount housing and a plurality of bases is each coupled to a respective one of the cables thereby facilitating each of the bases to be secured to the vertical support surface. A plurality of bands is each of the bands is retractably integrated into a respective one of the bases for securing the delivered packet on the respective base. A plurality of locking units releasably secures each of the bands on the respective base around the delivered package to inhibit the delivered package from being removed from the respective base by an unauthorized person.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to security devices and more particularly pertains to a new security device for securing a delivered package for retrieval by an intended recipient. The device includes a housing that is mounted to a support surface, a plurality of cables retractably integrated into the housing and a plurality of bases each coupled to a respective cable. The device includes a plurality of bands, each coupled to a respective base which can each be wrapped around a delivered package that is placed on the respective base. The device includes a plurality of locking units, each attached to a respective band, for locking the bands around the delivered package thereby inhibiting the delivered package from being stolen.

### (2) Description of Related Art including information disclosed under 37 CFR 1.97 and 1.98

The prior art relates to security devices including a package carrying device that includes a plurality of straps that can be wrapped around a package and a handle attached to the straps for carrying the package. The prior art discloses a security device that includes a housing, a plurality of cables that can be wrapped around an object and inserted into the housing and a plurality of locks disposed within the housing for securing the cables around the object. The prior art discloses a package security bag that includes a lock for closing the bag and a cable attached between the bag and a structure. The prior art discloses a cable lock device that includes cables, a lock and a cable tightener. The prior art discloses a security bag for storing a package delivery, a strap that is attached o the security bag which is insertable beneath a door and a stop attached to the strap to inhibit the strap from being pulled beneath the door. The prior art discloses an ornamental design for a cable lock that includes a cylinder and a plurality of cables each extending away from the cylinder.

### BRIEF SUMMARY OF THE INVENTION

An embodiment of the disclosure meets the needs presented above by generally comprising a mount housing that is mountable to a vertical support surface is located at a pre-determined location for a package delivery. A plurality of cables is each retractably integrated into the mount housing and a plurality of bases is each coupled to a respective one of the cables thereby facilitating each of the bases to be secured to the vertical support surface. A plurality of bands is each of the bands is retractably integrated into a respective one of the bases for securing the delivered packet on the respective base. A plurality of locking units releasably securing each of the bands on the respective base around the delivered package to inhibit the delivered package from being removed from the respective base by an unauthorized person.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a package security assembly according to an embodiment of the disclosure.

FIG. 2 is a phantom perspective view of a base of an embodiment of the disclosure.

FIG. 3 is a perspective view of a base of an embodiment of the disclosure.

FIG. 4 is a perspective view of a mount housing of an embodiment of the disclosure.

FIG. 5 is a top phantom view of a base of an embodiment of the disclosure.

FIG. 6 is a perspective phantom view of an embodiment of the disclosure.

FIG. 7 is a perspective in-use view of an embodiment of the disclosure.

FIG. 8 is a phantom detail view taken from circle 8 of FIG. 3 of an embodiment of the disclosure.

### DETAILED DESCRIPTION OF THE INVENTION

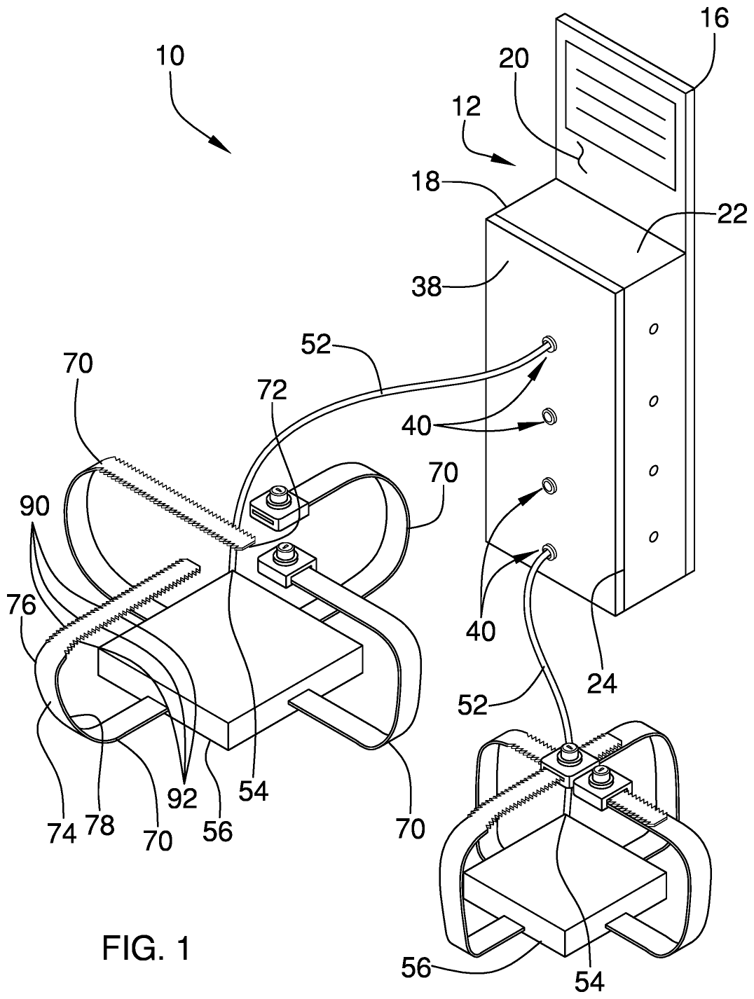

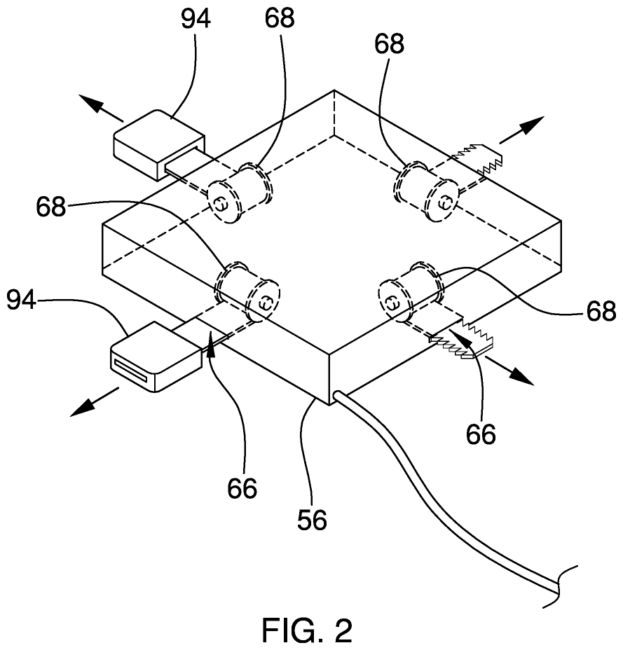

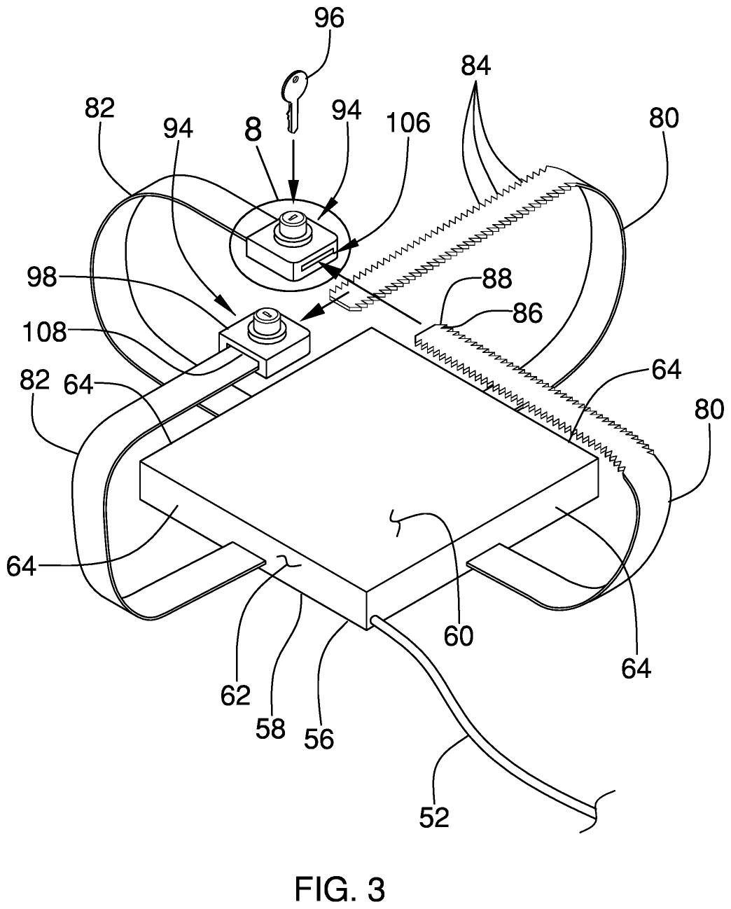

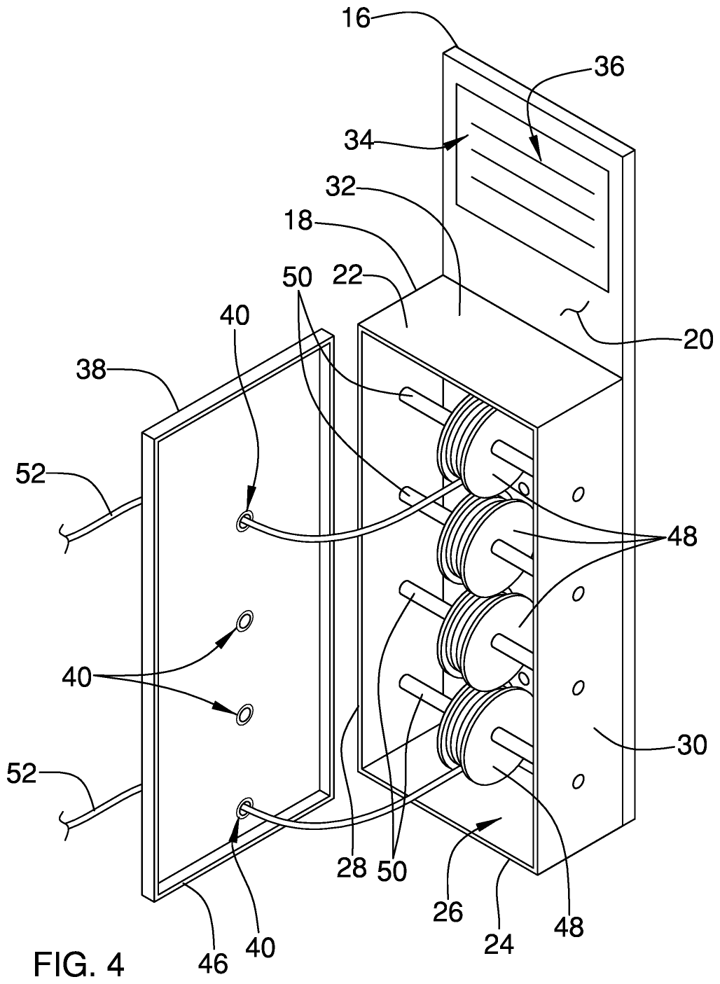

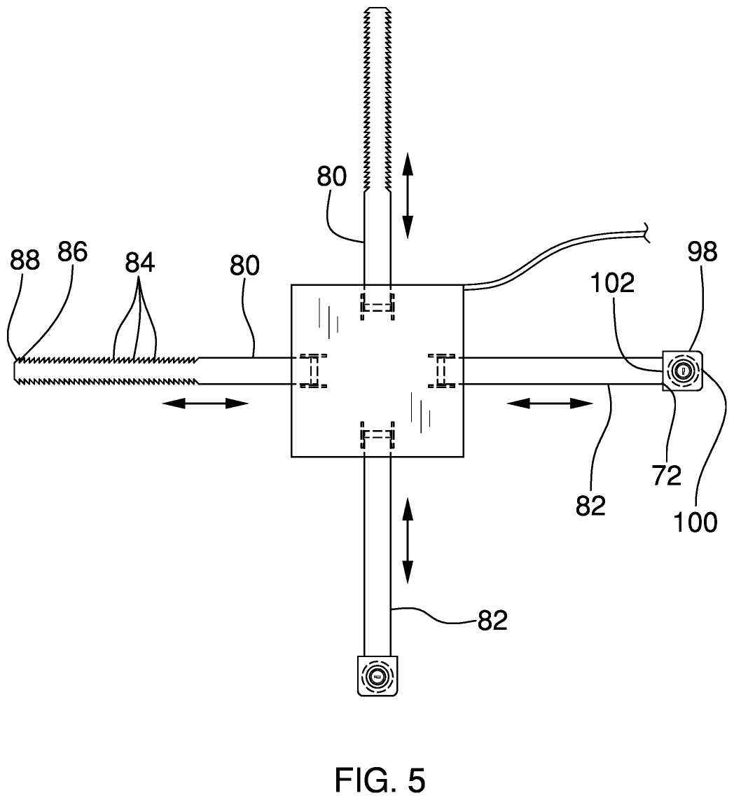

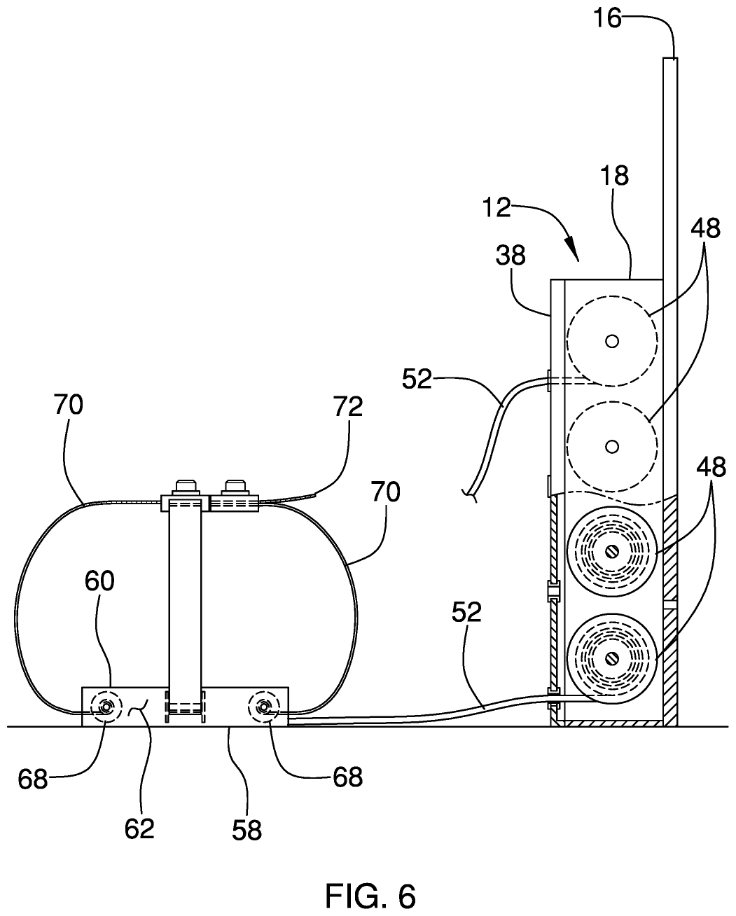

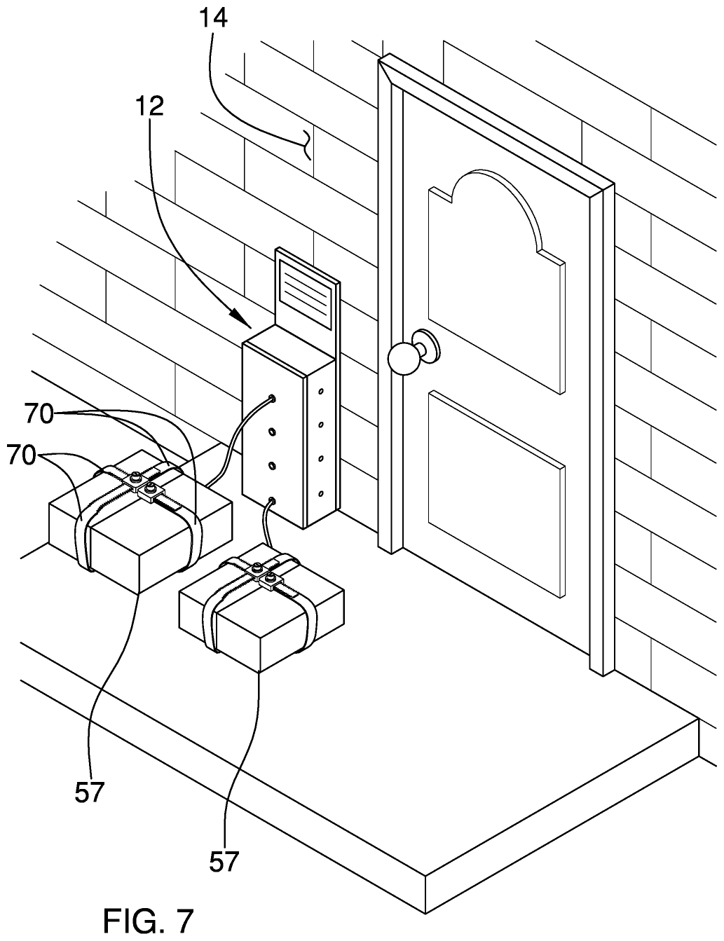

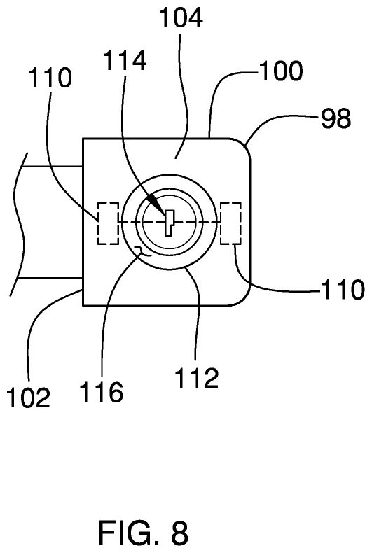

With reference now to the drawings, and in particular to FIGS. 1 through 8 thereof, a new security device embodying the principles and concepts of an embodiment of the disclosure and generally designated by the reference numeral 10 will be described.

As best illustrated in FIGS. 1 through 8, the package security assembly 10 generally comprises a mount housing 12 that is mountable to a vertical support surface 14 which is located at a pre-determined location for a package delivery. The pre-determined location for a package delivery may be a house or other location that commonly receives deliveries. The vertical support surface 14 may be a pole a wall or other type of structure positioned at the pre-determined location. The mount housing 12 has a rear panel 16 and a compartment 18 extending forwardly from a front surface 20 of the rear panel 16, and the compartment 18 has an outer wall 22 extending away from the front surface 20 of the rear panel 16. The outer wall 22 has a distal edge 24 with respect to the rear panel 16 to define an opening 26 into the compartment 18, and the outer wall 22 has a first lateral side 28, a second lateral side 30 and a top side 32. The rear panel 16 extends upwardly beyond the top side 32 to define an address portion 34 of the front surface 20 of the rear panel 16, and the address portion 34 has indicia 36 printed thereon comprising words and letters indicating a mailing address of the pre-determined location for the package delivery.

A lid 38 is positionable on the mount housing 12 for closing the mount housing 12, and the lid 38 has a plurality of holes 40 each extending through the lid 38. The lid 38 has rear side 42 and a front side 44, and each of the holes 40 extends through the front side 44 and the rear side 42. The holes 40 are spaced apart from each other and are distributed along a substantial height of the lid 38. The lid 38 has a lip 46 extending away from the rear side 42 and the lip 46 is aligned with and extends around a full perimeter of the lid 38. The lip 46 extends around the outer wall 22 of the compartment 18 when the lid 38 is positioned on the distal edge 24 of the outer wall 22 of the compartment 18.

A plurality of spools 48 is provided and each of the spools 48 is rotatably disposed within the compartment 18. Each of the spools 48 is biased to rotate in a first direction and each of the spools 48 is rotatable in a second direction. Each of the spools 48 includes an axle 50 extending between the first lateral side 28 and the second lateral side 30 of the outer wall 22 of the compartment 18. Furthermore, the spools 48 are spaced apart from each other and are distributed along a substantial height of the compartment 18.

A plurality of cables 52 is provided and each of the cables 52 is wrapped around a respective one of the spools 48. Each of the cables 52 extends outwardly through a respective one of the holes 40 in the lid 38 and each of the cables 52 has a distal end 54 with respect to the lid 38. Each of the cables 52 is wrapped around the respective spool 48 when the respective spool 48 rotates in the first direction and respective spools 48 rotate in the second direction when the cable 52 on the respective spool 48 is pulled outwardly through the respective hole 40 in the lid 38. A plurality of bases 56 is provided and each of the bases 56 is coupled to a respective one of the cables 52 thereby facilitating each of the bases 56 to be secured to the vertical support surface 14 for having a respective delivered package 57 is positioned on the bases 56.

Each of the bases 56 has a bottom surface 58, a top surface 60 and a perimeter surface 62 extending between the top surface 60 and the bottom surface 58, and the perimeter surface 62 of each of the bases 56 has a plurality of intersecting sides 64 such that each of the bases 56 has a rectangular shape. Additionally, each of the bases 56 has a plurality of slots 66 extending through a respective one of the intersecting sides 64 of the perimeter surface 62. A plurality of retractors 68 is each rotatably disposed within a respective one of the bases 56. Each of the retractors 68 is biased to rotate in a first direction and each of the retractors 68 is rotatable in a second direction. Furthermore, each of the retractors 68 is aligned with a respective one of the slots 66 in the perimeter surface 62 of the respective base 56.

A plurality of bands 70 is each retractably integrated into a respective one of the bases 56. Each of the bands 70 on each of the bases 56 is extendable around the delivered package 57 that is positioned on the respective base 56 for securing the delivered packet on the respective base 56. Each of the bands 70 is wrapped around a respective one of the retractors 68 in the respective base 56 when the respective retractor rotates in the first direction, and respective retractors 68 rotate in the second direction when the band 70 engaged to the respective retractor 68 is pulled outwardly from the respective base 56. Each of the bands 70 extends outwardly through a respective one of the slots 66 in the perimeter surface 62 of the respective base 56.

Each of the bands 70 has a distal end 72 with respect to the respective base 56 and an outer edge 74, and the outer edge 74 of each of the bands 70 has a first sidelong side 76 and a second sidelong side 78. The plurality of bands 70 on each of the bases 56 includes a pair of first bands 80 and a pair of second bands 82. Each of the first bands 80 on each of the bases 56 has a plurality teeth 84 integrated into the first bands 80, and the teeth 84 are spaced apart from each other and are distributed from the distal end 72 of a respective first band 80 toward the base 56. Each the teeth 84 has a first surface 86 and a second surface 88, and the first surface 86 of each of the teeth 84 extends along a line that is oriented parallel with the distal end 72 of the respective first band 80. Additionally, the second surface 88 of each of the teeth 84 angles away from the distal end 72 of the respective first band 80 such that each of the teeth 84 has a sawtooth shape.

The plurality of teeth 84 on each of the first bands 80 includes a set of first teeth 90 and a set of second teeth 92. Each of the first teeth 90 is disposed on the first sidelong side 76 of the respective first band 80 and each of the second teeth 92 is disposed on the second sidelong side 78 of the respective first band 80. Each of the first bands 80 is positioned on an opposing side of the perimeter surface 62 of the respective base 56 with respect to a respective one of the second bands 82 on the respective base 56.

A plurality of locking units 94 is provided and each of the locking units 94 is disposed on a respective one of the bands 70. Each of the locking units 94 releasably engages a respective one of the bands 70 on the respective base 56 thereby securing each of the bands 70 on the respective base 56 around the delivered package 57 that is positioned on the respective base 56. In this way the plurality of locking units 94 inhibit the delivered package 57 from being removed from the respective base 56 by an unauthorized person. Each of the locking units 94 is unlocked by a key 96 employed by an authorized recipient of the delivered package 57. In this way the locking units 94 facilitate the authorized user to retrieve the delivered package 57.

Each of the locking units 94 comprises a lock housing 98 that has a front wall 100, a back wall 102 and a top wall 104, and the back wall 102 is coupled to the distal end 72 of a respective one of the second bands 82. The front wall 100 has a front slot 106 extending into an interior of the lock housing 98 and the back wall 102 has a back slot 108 extending into the interior of the lock housing 98. The distal end 72 of a respective one of the first bands 80 is insertable into the front slot 106 having the first respective first band 80 extending outwardly through the back slot 108. Each of the locking units 94 includes a pair of engagements 110 and each of the engagements 110 is movably disposed within the lock housing 98. Each of the engagements 110 releasably engages a respective one of the teeth 84 on a respective one of the first sidelong side 76 and the second sidelong side 78 of the respective first band 80 thereby securing the respective first band 80 in the lock housing 98.

The second surface 88 of each of the teeth 84 slides along a respective engagement 110 when the respective first band 80 is extended through the lock housing 98. In this way the respective first band 80 can be tightened around the delivered package 57. The engagement 110 engages the first surface 86 of the respective tooth 84 when the respective first band 80 is pulled outwardly through the front side 44 thereby inhibiting the respective first band 80 from being removed from the lock housing 98. In this way the engagement 110 inhibits the unauthorized person from removing the delivered package 57 from the respective base 56

Each of the locking units 94 includes a release 112 that is movably integrated into the top wall 104 of the lock housing 98 and the release 112 is in mechanical communication with each of the engagements 110. The release 112 has a key hole 114 extending into an exposed surface 116 of the release 112 and the key hole 114 insertably receives the key 96 employed by the authorized user. The release 112 is urgeable into a releasing condition when the key 96 is inserted into the key hole 114. Furthermore, each of the engagements 110 disengages the respective teeth 84 on the respective first band 80 when the release 112 is urged into the releasing condition. In this way the respective first band 80 can be removed from the lock housing 98 to facilitate the authorized user to retrieve the delivered package 57 from the respective base 56.

In use, the delivered package 57 is placed on a respective one of the bases 56 and each of the first bands 80 and the second bands 82 associated with the respective base 56 are wrapped around the delivered package 57. Additionally, each of the first bands 80 is extended through the locking unit 94 on a respective second band 82 to secure each of the first bands 80 and the second bands 82 around the delivered package 57. In this way the delivered package 57 is secured to the respective base 56 and the respective base 56 is secured to the mount housing 12. Thus, the delivered package 57 cannot be stolen by an unauthorized user. The authorized user inserts the key 96 into the key hole 114 on the release 112 on each of the locking units 94 to facilitate the first bands 80 to be removed from the locking units 94. In this way the authorized user can retrieve the delivered package 57 from the respective base 56.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A package security assembly for securing a delivered package for an intended recipient, said assembly comprising:
a mount housing being mountable to a vertical support surface being located at a pre-determined location for a package delivery;
a lid being positionable on said mount housing for closing said mount housing, said lid having a plurality of holes each extending through said lid;
a plurality of cables, each of said cables retractably integrated into said mount housing, each of said cables extending outwardly through a respective one of said holes in said lid;
a plurality of bases, each of said bases being coupled to a respective one of said cables thereby facilitating each of said bases to be secured to the vertical support surface wherein each of said bases is configured to have a respective delivered package being positioned on said bases;
a plurality of bands, each of said bands being retractably integrated into a respective one of said bases, each of said bands on each of said bases being extendable around the delivered package that is positioned on said respective base for securing the delivered packet on said respective base; and
a plurality of locking units, each of said locking units being disposed on a respective one of said bands, each of said locking units releasably engaging a respective one of said bands on said respective base thereby securing each of said bands on said respective base around the delivered package that is positioned on said respective base wherein said plurality of locking units is configured to inhibit the delivered package from being removed from said respective base by an unauthorized person, each of said locking units being unlocked by a key employed by an authorized recipient of the delivered package wherein said locking units are configured to facilitate the authorized user to retrieve the delivered package.

2. The assembly according to claim 1, wherein said mount housing has a rear panel and a compartment extending forwardly from a front surface of said rear panel, said compartment having an outer wall extending away from said front surface of said rear panel, said outer wall having a distal edge with respect to said rear panel to define an opening into said compartment, said outer wall having a first lateral side, a second lateral side and a top side, said rear panel extending upwardly beyond said top side to define an address portion of said front surface of said rear panel, said address portion having indicia being printed thereon comprising words and letters indicating a mailing address of the pre-determined location for the package delivery.

3. The assembly according to claim 2, wherein said lid has rear side and a front side, each of said holes extending through said front side and said rear side, said holes being spaced apart from each other and being distributed along a substantial height of said lid, said lid having a lip extending away from said rear side, said lip being aligned with and extending around a full perimeter of said lid, said lip extending around said outer wall of said compartment when said lid is positioned on said distal edge of said outer wall of said compartment.

4. The assembly according to claim 2, further comprising a plurality of spools, each of said spools being rotatably disposed within said compartment, each of said spools being biased to rotate in a first direction, each of said spools being rotatable in a second direction, each of said spools including an axle extending between said first lateral side and said second lateral side of said outer wall of said compartment, said spools being spaced apart from each other and being distributed along a substantial height of said compartment.

5. The assembly according to claim 4, wherein each of said cables is wrapped around a respective one of said spools, each of said cables has a distal end with respect to said lid, each of said cables being wrapped around said respective spool when said respective spool rotates in said first direction, respective spools rotating in said second direction when said cable on said respective spool is pulled outwardly through said respective hole in said lid.

6. The assembly according to claim 1, wherein:
each of said bases has a bottom surface, a top surface and a perimeter surface extending between said top surface and said bottom surface, said perimeter surface of each of said bases having a plurality of intersecting sides such that each of said bases has a rectangular shape, each of said bases having a plurality of slots extending through a respective one of said intersecting sides of said perimeter surface;
said assembly includes a plurality of retractors, each of said retractors being rotatably disposed within a respective one of said bases, each of said retractors being biased to rotate in a first direction, each of said retractors being rotatable in a second direction, each of said retractors is aligned with a respective one of said slots in said perimeter surface of said respective base; and
each of said bands extends outwardly through a respective one of said slots in said perimeter surface of said respective base.

7. The assembly according to claim 6, wherein each of said bands is wrapped around a respective one of said retractors in said respective base when said respective retractor rotates in said first direction, respective retractors rotating in said second direction when said band engaged to said respective retractor is pulled outwardly from said respective base.

8. The assembly according to claim 1, wherein:
each of said bands has a distal end with respect to said respective base and an outer edge, said outer edge of each of said bands having a first sidelong side and a second sidelong side;
said plurality of bands on each of said bases including a pair of first bands and a pair of second bands; and
each of said first bands on each of said bases has a plurality teeth being integrated into said first bands, said teeth being spaced apart from each other and being distributed from said distal end of a respective first band toward said base.

9. The assembly according to claim 8, wherein each said teeth has a first surface and a second surface, said first surface of each of said teeth extending along a line being oriented parallel with said distal end of said respective first band, said second surface of each of said teeth angling away from said distal end of said respective first band such that each of said teeth has a sawtooth shape.

10. The assembly according to claim 9, wherein said plurality of teeth on each of said first bands includes a set of first teeth and a set of second teeth, each of said first teeth being disposed on said first sidelong side of said respective first band, each of said second teeth being disposed on said second sidelong side of said respective first band, each of said first bands being positioned on an opposing side of said perimeter surface of said respective base with respect to a respective one of said second bands on said respective base.

11. The assembly according to claim 1, wherein:
said plurality of bands on each of said bases includes a pair of first bands and a pair of second bands; and
each of said locking units comprises a lock housing having a front wall, a back wall and a top wall, said back wall being coupled to a distal end of a respective one of said second bands, said front wall having a front slot extending into an interior of said lock housing said back wall having a back slot extending into said interior of said lock housing, a distal end of a respective one of said first bands being insertable into said front slot having said first respective first band extending outwardly through said back slot; and
each of said locking units includes a pair of engagements, each of said engagements being movably disposed within said lock housing, each of said engagements releasably engaging a respective one of said teeth on a respective one of said first sidelong side and said second sidelong side of said respective first band thereby securing said respective first band in said lock housing.

12. The assembly according to claim 11, wherein said second surface of each of said teeth slides along a respective engagement when said respective first band is extended through said lock housing thereby facilitating said respective first band to be tightened around the delivered package, said engagement engaging said first surface of said respective tooth when said respective first band is pulled outwardly through said front side thereby inhibiting said respective first band from being removed from said lock housing wherein said engagement is configured to inhibit the unauthorized person from removing the delivered package from said respective base.

13. The assembly according to claim 11, wherein:
each of said locking units includes a release being movably integrated into said top wall of said lock housing, said release being in mechanical communication with each of said engagements, said release having a key hole extending into an exposed surface of said release, said key hole insertably receiving said key employed by the authorized user, said release being urgeable into a releasing condition when said key is inserted into said key hole; and
each of said engagements disengages said respective teeth on said respective first band when said release is urged into said releasing condition thereby facilitating said respective first band to be removed from said lock housing wherein said release is configured to facilitate the authorized user to retrieve the delivered package from said respective base.

14. A package security assembly for securing a delivered package for an intended recipient, said assembly comprising:
a mount housing being mountable to a vertical support surface being located at a pre-determined location for a package delivery, said mount housing having a rear panel and a compartment extending forwardly from a front surface of said rear panel, said compartment having an outer wall extending away from said front surface of said rear panel, said outer wall having a distal edge with respect to said rear panel to define an opening into said compartment, said outer wall having a first lateral side, a second lateral side and a top side, said rear panel extending upwardly beyond said top side to define an address portion of said front surface of said rear panel, said address portion having indicia being printed thereon comprising words and letters indicating a mailing address of the pre-determined location for the package delivery;
a lid being positionable on said mount housing for closing said mount housing, said lid having a plurality of holes each extending through said lid, said lid having rear side and a front side, each of said holes extending through said front side and said rear side, said holes being spaced apart from each other and being distributed along a substantial height of said lid, said lid having a lip extending away from said rear side, said lip being aligned with and extending around a full perimeter of said lid, said lip extending around said outer wall of said compartment when said lid is positioned on said distal edge of said outer wall of said compartment;
a plurality of spools, each of said spools being rotatably disposed within said compartment, each of said spools being biased to rotate in a first direction, each of said spools being rotatable in a second direction, each of said spools including an axle extending between said first lateral side and said second lateral side of said outer wall of said compartment, said spools being spaced apart from each other and being distributed along a substantial height of said compartment;
a plurality of cables, each of said cables being wrapped around a respective one of said spools, each of said cables extending outwardly through a respective one of said holes in said lid, each of said cables having a distal end with respect to said lid, each of said cables being wrapped around said respective spool when said respective spool rotates in said first direction, respective spools rotating in said second direction when said cable on said respective spool is pulled outwardly through said respective hole in said lid;
a plurality of bases, each of said bases being coupled to a respective one of said cables thereby facilitating each of said bases to be secured to the vertical support surface wherein each of said bases is configured to have a respective delivered package being positioned on said bases, each of said bases having a bottom surface, a top surface and a perimeter surface extending between said top surface and said bottom surface, said perimeter surface of each of said bases having a plurality of intersecting sides such that each of said bases has a rectangular shape, each of said bases having a plurality of slots extending through a respective one of said intersecting sides of said perimeter surface;
a plurality of retractors, each of said retractors being rotatably disposed within a respective one of said bases, each of said retractors being biased to rotate in a first direction, each of said retractors being rotatable in a second direction, each of said retractors being aligned with a respective one of said slots in said perimeter surface of said respective base;
a plurality of bands, each of said bands being retractably integrated into a respective one of said bases, each of said bands on each of said bases being extendable around the delivered package that is positioned on said respective base for securing the delivered packet on said respective base, each of said bands being wrapped around a respective one of said retractors in said respective base when said respective retractor rotates in said first direction, respective retractors rotating in said second direction when said band engaged to said respective retractor is pulled outwardly from said respective base, each of said bands extending outwardly through a respective one of said slots in said perimeter surface of said respective base, each of said bands having a distal end with respect to said respective base and an outer edge, said outer edge of each of said bands having a first sidelong side and a second sidelong side, said plurality of bands on each of said bases including a pair of first bands and a pair of second bands, each of said first bands on each of said bases having a plurality teeth being integrated into said first bands, said teeth being spaced apart from each other and being distributed from said distal end of a respective first band toward said base, each said teeth having a first surface and a second surface, said first surface of each of said teeth extending along a line being oriented parallel with said distal end of said respective first band, said second surface of each of said teeth angling away from said distal end of said respective first band such that each of said teeth has a sawtooth shape, said plurality of teeth on each of said first bands including a set of first teeth and a set of second teeth, each of said first teeth being disposed on said first sidelong side of said respective first band, each of said second teeth being disposed on said second sidelong side of said respective first band, each of said first bands being positioned on an opposing side of said perimeter surface of said respective base with respect to a respective one of said second bands on said respective base; and
a plurality of locking units, each of said locking units being disposed on a respective one of said bands, each of said locking units releasably engaging a respective one of said bands on said respective base thereby securing each of said bands on said respective base around the delivered package that is positioned on said respective base wherein said plurality of locking units is configured to inhibit the delivered package from being removed from said respective base by an unauthorized person, each of said locking units being unlocked by a key employed by an authorized recipient of the delivered package wherein said locking units are configured to facilitate the authorized user to retrieve the delivered package, each of said locking units comprising:
a lock housing having a front wall, a back wall and a top wall, said back wall being coupled to said distal end of a respective one of said second bands, said front wall having a front slot extending into an interior of said lock housing said back wall having a back slot extending into said interior of said lock housing, said distal end of a respective one of said first bands being insertable into said front slot having said first respective first band extending outwardly through said back slot;
a pair of engagements, each of said engagements being movably disposed within said lock housing, each of said engagements releasably engaging a respective one of said teeth on a respective one of said first sidelong side and said second sidelong side of said respective first band thereby securing said respective first band in said lock housing, said second surface of each of said teeth sliding along a respective engagement when said respective first band is extended through said lock housing thereby facilitating said respective first band to be tightened around the delivered package, said engagement engaging said first surface of said respective tooth when said respective first band is pulled outwardly through said front side thereby inhibiting said respective first band from being removed from said lock housing wherein said engagement is configured to inhibit the unauthorized person from removing the delivered package from said respective base; and
a release being movably integrated into said top wall of said lock housing, said release being in mechanical communication with each of said engagements, said release having a key hole extending into an exposed surface of said release, said key hole insertably receiving said key employed by the authorized user, said release being urgeable into a releasing condition when said key is inserted into said key hole, each of said engagements disengaging said respective teeth on said respective first band when said release is urged into said releasing condition thereby facilitating said respective first band to be removed from said lock housing wherein said release is configured to facilitate the authorized user to retrieve the delivered package from said respective base.
